(19) United States
(12) Patent Application Publication
(10) Pub. No.: US 2012/0173568 A1
(43) Pub. Date: Jul. 5, 2012

(54) GETTING INDIVIDUAL ROW COUNTS FROM RELATED TABLES MATCHING SELECTION CRITERIA

(75) Inventors: Sheshnarayan Agrawal, Bangalore (IN); Balachandra Kamat, Belgaum (IN)

(73) Assignee: INTERNATIONAL BUSINESS MACHINES CORPORATION, Armonk, NY (US)

(21) Appl. No.: 12/984,366

(22) Filed: Jan. 4, 2011

(51) Int. Cl. G06F 17/30

(52) U.S. Cl. 707/769; 707/E17.014

(57) ABSTRACT

Methods and apparatus, including computer program products, implementing and using techniques for querying a database system. A user input is received on a client computer. The user input includes a single select query operable to obtain individual row counts of two or more related database tables in the database, wherein the row counts match a selection criterion in the single select query. The query is received at the database system. Row counts are obtained from the two or more related database tables in the database and the row counts are assembled into a query response. The query response with the individual row counts is presented to the user on the client computer.

### BACKGROUND

The present invention relates to Relational Database Management Systems (RDBMS), and more specifically, to obtaining record counts from multiple tables in an RDBMS. Computers have become a pervasive tool for storing and providing access to vast amounts of information. A common way to store information on computer systems, while providing easy access for users is to use computer databases. A typical database is an organized collection of related information stored as “records” having “fields” of information.

RDBMS is a common type of data base management systems. In an RDBMS, all data is externally structured into tables. A table can be described as a two-dimensional entity having rows and columns. Each column has a name that typically describes the type of data held in the column, and as new data is added more rows are inserted into the table. Structured query language (SQL) statements allow users to perform operations on the data stored in the RDBMS. The SQL statements can be used, for example, to generate sets of data that fulfill certain criteria, by selecting data from one or more of the tables in the RDBMS. The resulting set of data is typically stored in a result table. For example, a SQL query can include a SELECT statement and a WHERE clause to qualify rows according to a predicate. An application can then access the data on a row-by-row basis from the result table.

In some situations, a user may need to know the row counts for individual related tables in an RDBMS that match certain search criteria. Currently, there is no convenient way of achieving this, especially in situations where there is one start table and multiple related child tables. Typically, the way to obtain row counts for all the individual tables is to do a ‘select count(*)’ query for a single table (starting from the start table), fetch the rows matching the selection criteria and storing them in a buffer, and then using the data in the buffer to query the individual child tables. Performing multiple queries like these can often get complicated, especially when there are relationships between tens or even hundreds of tables. In addition, if data from the tables is buffered on remote systems this may lead to network congestion issues and system performance degradation.

### SUMMARY

According to one aspect, various embodiments of the invention provide method and apparatus, including computer program products, for querying a database system. A user input is received on a client computer. The user input includes a single select query operable to obtain individual row counts of two or more related database tables in the database, wherein the row counts match a selection criterion in the single select query. The query is received at the database system. Row counts are obtained from the two or more related database tables in the database and the row counts are assembled into a query response. The query response with the individual row counts is presented to the user on the client computer.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic diagram of an exemplary system (100), in which various embodiments of the invention can be implemented.

FIG. 2 is a schematic flowchart of a process (200) for submitting and executing a select query, in accordance with one embodiment.

FIG. 3 is a schematic illustration of four hierarchically arranged tables (302, 304, 306, 308) in an RDBMS, in accordance with one embodiment.

FIG. 4 is a schematic illustration of a result of performing the select query on the tables of FIG. 3, in accordance with one embodiment.

Like reference symbols in the various drawings indicate like elements.

### DETAILED DESCRIPTION

On a general level, the various embodiments of the invention relate to methods and apparatus, including computer program products, for getting individual row counts from all related tables in a RDBMS that match a specific selection criterion. In particular, in one embodiment, a new SQL select query is provided, which allows users to use a new data type to perform a search across multiple tables in a RDBMS to obtain the row counts of the individual tables in the from clause of the SQL select query. In one embodiment, the row counts are presented to the user in a tabular format, in which each row contains the table name and the count of the number of rows in that particular table that match the selection criterion.

Having a SQL query in accordance with the various embodiments of the invention can be useful in a variety of situations and lead to significant advantages. Obviously, one benefit is that a user can issue a single query only and obtain the individual row counts of all the tables in the select query, instead of having to perform multiple queries, which is more convenient for the user. Network congestion can be reduced, since there is no need to buffer data for each table on the client, but instead all operations are done on the database end before any results are sent to the client, which results in significant performance benefits.

One area in which a select query in accordance with various embodiments of the invention may be useful is for purposes of resource estimation of storage. For example, a database a schema is the structure of the database that defines the objects in the database. In an RDBMS context, the schema identifies, for example, tables, fields, relationships, views, indexes, etc. Sometimes it is necessary to move data from one schema to another schema. When moving data, typically a database administrator would constantly have to estimate the space needed for achieving such a move. In a situation with large databases that contain large numbers of tables, it would be unfeasible from a practical point of view to perform enough individual queries to get the row counts for all tables matching the selection criteria. However, with a new select query in accordance with the various embodiments described herein, only a single query would need to be performed, which would provide immediate results of the resources needed to the database administrator.

A similar situation where resource estimation is important is when client applications need to estimate the storage space (i.e., hard disk space) required to archive data from a database. Using a single select query in accordance with the various embodiments described herein by the client application allows the client application to better estimate the hard disk space required. It should be noted that these are just some representative examples, and that those of ordinary skill in the art can envision several similar, as well as other, areas in which the select query of the various embodiments can be useful.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

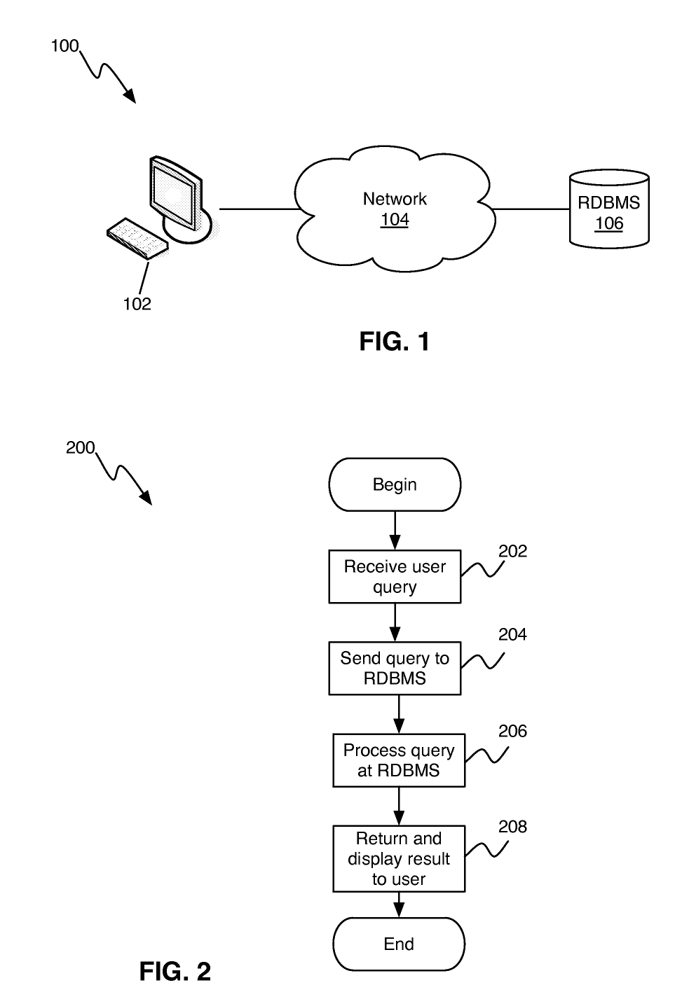

FIG. 1 shows a schematic diagram of an exemplary system (100), in which various embodiments of the invention can be implemented. The system (100) includes a client computer (102), which is operable to access a server (106) hosting a RDBMS through a network (104). For reasons of simplicity, only one client computer (102) and one database server (106) is illustrated, while in a real-life situation, there are typical multiple client computers (102) and the RDBMS can be distributed across several database servers (106). The network (104) can be any wireless or wired network, or a combination thereof, as are well known to those of ordinary skill in the art.

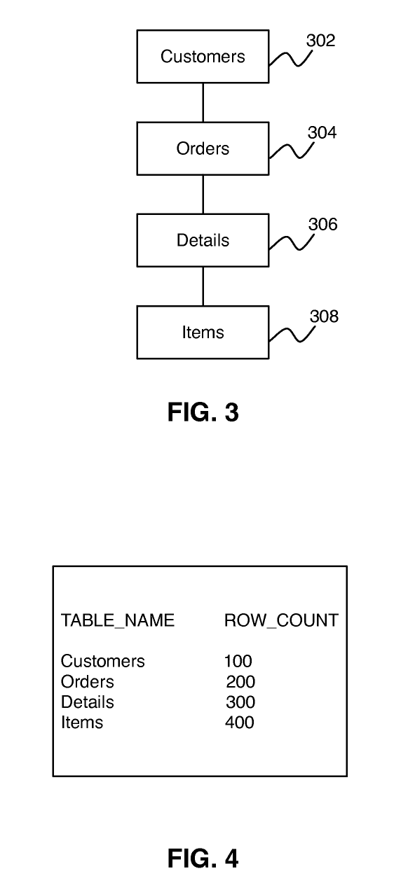

FIG. 2 shows a flowchart of a process (200) for submitting a select query from a client computer (102) to a remote RDBMS (106) in accordance with one embodiment. In this example, it is assumed that the RDBMS (106) contains four tables (302, 304, 306, 308), as shown in FIG. 3. The tables have a strict hierarchical relationship, that is, the Customers table (302) at the top level has a child table, Orders (304), which in turn has a child table Details (306), which has a child table Items (308). In a real life RDBMS (106), there may be much more complex relationships among hundreds of objects.

As can be seen in FIG. 2, the process (200) starts by a user entering a select query (step 202). For example, the selection criterion can be to select the first 100 customers from the Customers table (302). In one embodiment, the select query can be entered as:

Select getRowCountArray

from Customers C, Orders O, Details D, Items I

| where C.cust_id = O.cust_id AND | |
|---|---|
| | O.Order_id = D.Order_id AND |
| | D.item_id = I.item_id AND |
| AND | C.cust_id > 100 AND C.cust_id < 1000; |

The structure for getRowCountArray in this example is:

Struct GETROWCOUNTARRAY
{

| TCHAR * tableviewname; | |
|---|---|
| ULONG | Count; |

}* getRowCountArray;

In some embodiments the allocation can be static, as shown below:

{

| TCHAR tableviewname[MAX_COUNT_FOR_TBALE_NAMES]; | |
|---|---|
| ULONG | Count; |

}
getRowCountArray[MAX_COUNT_OF_TABLES_VIEWS_IN_A_SQL_OUERY]
;

In some embodiments, the variable types can be changed, for example as shown below:

Struct GETROWCOUNTARRAY
{

<String, including wide char i.e. WCHAR> tableviewname;
<Any numeric type i.e. FLOAT, NUMBER, DECIMAL etc> Count;

}* getRowCountArray;

The select query is then sent from the client computer (102) over the network (104) to the RDBMS (106) (step 204), where it is processed (step 206). The RDBMS (106) has all the information that is needed to process the query, so there is no need for any back-and-forth data transfer between the RDBMS (106) and the client computer (102).

When the RDBMS (106) is done processing the query, the results are returned and displayed to the user (step 208). In one embodiment, the results are displayed in the form of a tabular (400) as shown in FIG. 4, but as the skilled person realizes, there are many other ways in which the results could be displayed. Such modifications are trivial to those of ordinary skill in the art and fall within the scope of the appended claims. As can be seen in FIG. 4, the Customers table (302) contains 100 rows that match the selection criterion, the Orders table (304) contains 200 rows that match the selection criterion, the Details table (306) contains 300 rows that match the selection criterion and the Items table (308) contains 400 rows that match the selection criterion. Thus, the user or database administrator has an accurate row count for how many rows in each of the individual tables match the selection criterion.

A number of embodiments of the invention have been described. Nevertheless, it will be understood that various modifications may be made without departing from the spirit and scope of the invention. For example, while the various embodiments have been described with respect to the Structured Query Language, it should be noted that the inventive concepts described herein are also applicable to other query languages, as can be envisioned by those of ordinary skill in the art. Accordingly, other embodiments are within the scope of the following claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method for querying a database system, the method comprising:
receiving a user input on a client computer, the user input including a single select query operable to obtain individual row counts of two or more related database tables in the database, wherein the row counts match a selection criterion in the single select query;
receiving the query at the database system;
obtaining row counts from the two or more related database tables in the database and assembling the row counts into a query response; and
presenting the query response with the individual row counts to the user on the client computer.

2. The method of claim 1, wherein the database system is a Relational Database Management System.

3. The method of claim 1, wherein the single select query is expressed in a Structured Query Language.

4. The method of claim 1, wherein presenting the query response includes displaying the query response in a grid format, in which each row includes a table name and a row count for the table.

5. The method of claim 1, wherein all query processing is conducted by the database system without interacting with the client computer until the query response has been assembled.

6. A computer program product for querying a database system, the computer program product comprising:
a computer readable storage medium having computer readable program code embodied therewith, the computer readable program code comprising:
computer readable program code configured to receive a user input on a client computer, the user input including a single select query operable to obtain individual row counts of two or more related database tables in the database, wherein the row counts match a selection criterion in the single select query;
computer readable program code configured to receive the query at the database system;
computer readable program code configured to obtain row counts from the two or more related database tables in the database and assembling the row counts into a query response; and
computer readable program code configured to present the query response with the individual row counts to the user on the client computer.

7. The computer program product of claim 6, wherein the database system is a Relational Database Management System.

8. The computer program product of claim 6, wherein the single select query is expressed in a Structured Query Language.

9. The computer program product of claim 6, wherein the computer readable program code configured to present the query response includes computer readable program code configured to display the query response in a grid format, in which each row includes a table name and a row count for the table.

10. The computer program product of claim 6, wherein all query processing is conducted by the database system without interacting with the client computer until the query response has been assembled.

11. A system for performing a database system query, the system comprising:
a client computer, the client computer being operable to receive a user input on a client computer, the user input including a single select query operable to obtain individual row counts of two or more related database tables in the database, wherein the row counts match a selection criterion in the single select query; and
a server hosting a database, the database being operable to:
receive the query;
obtaining row counts from the two or more related database tables in the database and assembling the row counts into a query response; and
send the query response with the individual row counts to the user on the client computer.

12. The system of claim 11, wherein the database system is a Relational Database Management System.

13. The system of claim 11, wherein the single select query is expressed in a Structured Query Language.

14. The system of claim 11, wherein the client computer is further operable to display the query response to the user in a grid format, in which each row includes a table name and a row count for the table.

15. The system of claim 11, wherein all query processing is conducted by the database system without interacting with the client computer until the query response has been assembled.
